(19) United States
(12) Patent Application Publication
(10) Pub. No.: US 2010/0043626 A1
(43) Pub. Date: Feb. 25, 2010

(54) AUTOMATIC TONE-FOLLOWING METHOD AND SYSTEM FOR MUSIC ACCOMPANYING DEVICES

(76) Inventor: Wen-Hsin Lin, Taichung City (TW)

Correspondence Address: EGBERT LAW OFFICES, 412 MAIN STREET, 7TH FLOOR, HOUSTON, TX, 77002, US

(21) Appl. No.: 12/442,937

(22) PCT Filed: Sep. 26, 2006
(86) PCT No.: PCT/CN06/02535

§ 371 Date: Mar. 25, 2009

(51) Int. Cl. G10H 1/36; G10H 1/06

(52) U.S. Cl. 84/610; 84/692

(57) ABSTRACT

The present invention provides an automatic tone-following method and system for music accompanying devices, which detects the frequency of the singer's voice instantly and continuously and compares it with the theme tone frequency of the accompanying music to estimate the error between the tones of the singer and the music so as to adjust the tone of the music to match the tone of the singer's voice. The present invention calculates the fundamental frequency of the user's voice every short section of time through a tone estimator, then converts the fundamental frequency of the user's voice into user scale sequence in a scale sequence recorder, then compares the difference between the user scale sequence and the theme scale sequence through a scale matcher. Whether a transposition is needed through a transposition judger is determined so that the scale parameter in the music synthesizer can be adjusted.

### BACKGROUND OF INVENTION

1. Field of the Invention

The present invention relates generally to an automatic tone-following method for music accompanying devices, as well as an innovative design of a tone-following system.

2. Description of Related Art

For general people, when singing a song along with the accompanying music (for example, using a karaoke machine), the pitch gets lost easily due to the over-high or over-low tone of the accompanying music and the tone of the singer cannot catch up with the tone of the accompanying music. As a result, there will be a disharmony between the rhythm of the song and that of the music, which greatly affects the effect of singing.

In view of the aforementioned problem, related manufacturers have developed an apparatus for the music accompanying device to change the tone of the accompanying music according to the tone of the singer. However, the technology adopted is to measure the tone of the singer in a preset time cycle, and obtain an “average tone” within this time cycle through calculation. Then, the “average tone” is compared to the reference tone of a matching accompanying music to provide a disharmony signal, and accordingly change the tone of the accompanying music. However, in such prior-art automatic tone-following method for accompanying music, the calculation of the tone of the singer is to obtain an average value (i.e. average tone) within a time cycle. Therefore, each time interval (e.g. 5 sec) for which an average value is obtained has already caused an obvious delay in comparison with the singing. Moreover, the time needed for calculation and comparison will make the delay more obvious. Hence, in actual application, in such prior-art automatic tone-following method for accompanying music, the process to change the tone of the accompanying music to meet the tone of the singer cannot achieve a good instantaneity. Change of the tone of the accompanying music will often occur after the singer has completed one sentence of the lyric and is going on to the next sentence.

Also, as the method disclosed above is to compare the values between two fixed points, it is difficult to obtain an accurate transposition value. Therefore it cannot meet the expectation of the user, and has a room to be improved.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

1. The automatic tone-following method for music accompanying devices disclosed in the present invention does not calculate the user's voice tone to obtain an average value, but calculate it every a section of time (e.g. 0.1), and uses the scale sequence recorder 12 to convert the fundamental frequency of the user's voice into user scale sequence 121; That is to say, the present invention compares theme scale sequence 14 and user voice scale sequence 121, instead of comparing its average tone. The scale matcher 13 compares the matching degree of a section of scale sequence. This is a mode of dynamic comparison of the scale curve before outputting the scale difference upon optimum matching, because the scale matcher 13 dynamically compares the scale sequence curve in a certain period of time, instead of comparing the average value of tone in a certain period of time. Hence, the transposition value obtained has a higher accuracy, and an optimum tone adjustment effect can be obtained to better meet user's need.
2. The technical features of the present invention are as follow: direct acquisition of the theme of the recorded song; no need for complicated calculation processes; low system computation load; low occupation of system resources; and consequently higher operational efficiency and instantaneity. Hence, the present invention has achieved a practical advancement by considerably improving the problem of delay in prior-art systems. Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1 is a systematic block diagram of the automatic tone-following method for music accompanying devices of the present invention.

FIG. 2 is a block diagram of the action process of the scale matcher of the present invention.

### DETAILED DESCRIPTION OF THE INVENTION

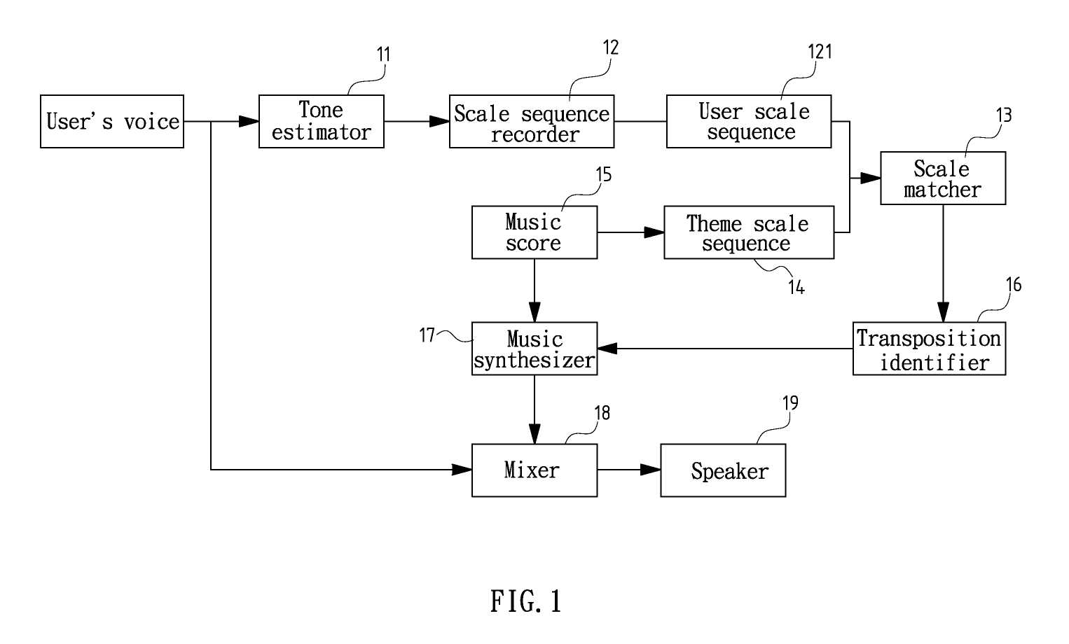

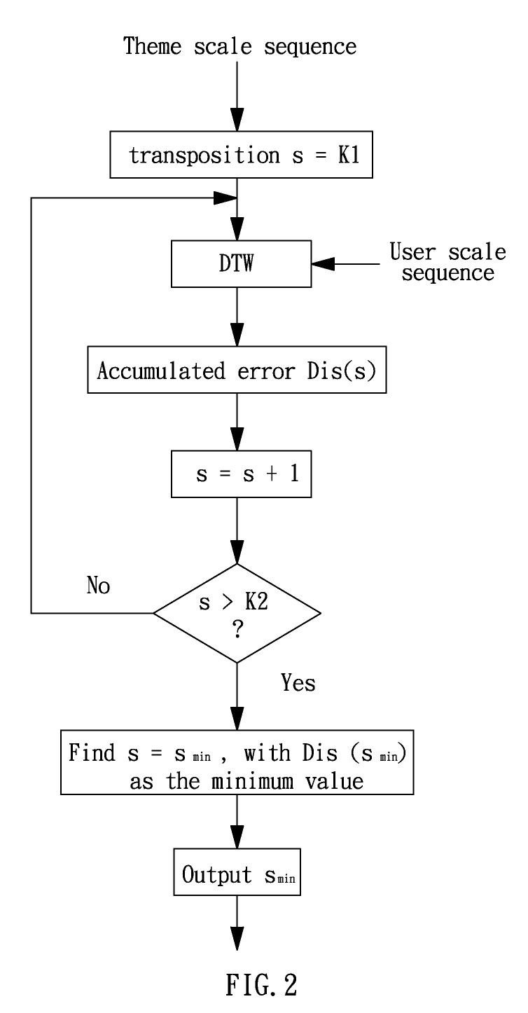

FIGS. 1 and 2 depict a preferred embodiment of the automatic tone-following method for music accompanying devices according to the present invention. While such an embodiment is for description purpose only, its structure shall not limit the range of patent application; said automatic tone-following method is described as below:

As shown in FIG. 1, for each small section of time (about 0.1 sec), the fundamental frequency is calculated through a tone estimator 11. The tone estimator 11 calculates the fundamental cycle or frequency of this section of sound, which can be obtained through an autocorrelation function calculating the maximum value, or through the relative position or distance of the peak value. The relation between the cycle and frequency is:

Fundamental frequency=sampling frequency/fundamental cycle

The sampling frequency is the number of sound points sampled in each second. Then, in a scale sequence recorder 12, a succession of the fundamental frequencies of the input sound of the user is converted into a user scale sequence 121, which is then recorded. The relation between scale and frequency is as below:

When the scale is A4, the frequency is 440 Hz. When the scale is increased by a semitone, the frequency is increased by [symbol] , and likewise, when the scale is decreased by a semitone, the frequency is decreased by [symbol] . Therefore, when the scale is increased by 12 steps, the frequency will increase by twice. Then, through a scale matcher 13, the user scale sequence 121 is calculated and compared to the theme scale sequence 14 to obtain the difference. Here, the theme scale sequence 14 is in advance stored in the music text 15, for example: in a midi (musical instrument digital interface) file, such information of the music text can be stored at the same time. The scale matcher 13 uses a method of Dynamic Time Warping (or DTW) correction to compare the difference between the user scale sequence and theme scale sequence 14, as detailed below:

Assume user scale sequence 121 is n1, n2, . . . , nj, each representing the scale (tone) of the user (singer) calculated for each section of time (e.g. 0.1 sec), and assume theme scale sequence 14 is m1, m2, . . . , mj, each representing the theme scale in each section of time (e.g. 0.1 sec). Here, the scales are represented as numbers 1˜255, for example, scale C3 is represented as 60, scale D3 is represented as 61, scale B3 is represented as 59, and so forth. Because during the singing, the position of the beat point of the singer's voice may not be the same as the background, a dynamic time correction shall be made during the comparison of time scale, so as to generate correct comparison results, as shown in the following figure:

In the embodiment disclosed above, from the angle of time, the n2, n3 (i.e. user scale sequence) will be corrected according to m2 (i.e. theme scale sequence), so that the beat point positions of the background music can be compared with the beat point positions of the singer's voice at correct and corresponding beat point positions; during transposition, the theme scale sequence transposes along with the user scale sequence.

Assume dist (ni,mk) represents the error between scale ni and mk, acu_dist (ni,mk) represents the accumulated error from the past optimum path to scale ni,mk, then the minimum accumulated error of each node matched in the above figure is:

acu_dist(ni,mk)=dist(ni,mk)+min{acu_dist(ni−1,mk), acu_dist(ni,mk−1), acu_dist(ni−1,mk−1), . . . }

wherein, min{. . . } represents the minimum value, the range in {. . . } is decided in an empirical method. Generally, a range between −2˜+2 is selected for the time correction value, therefore the error of last matching result is acu_dist(nj,mj), j is the last time point in this comparison, its value is decided by experiment and is usually higher than 40 (4 sec) and lower than 100 (10 sec). Optimum path refers to the path with minimum accumulated error. In practice, it does not need to be calculated.

Based on the above method, we can calculate how much transposition is needed for the theme. As shown in FIG. 2, firstly set theme scale transposition value s=K1, s=1 means the scale is increased by a half, s=−1 means the scale is decreased by a half. Then, use the above method (i.e. the aforementioned Dynamic Time Warping (DTW) correction method) to compare the user scale sequence and the theme scale sequence after transposition and record the accumulated error=Dis(s) of the last matching result. Then, assume s=s+1, and calculate Dis(s) again till s=K2, and finally find the transposition value s=sₘᵢₙ, with Dis (sₘᵢₙ) as the minimum value, where K1<=s<=K2. Usually, assume K1=−6, K2=6.

Then, a transposition judger 16 is used to decide if and when the transposition is needed. The transposition judger 16 processes transposition when the error Dis(sₘᵢₙ) is lower than a constant empirical value D. In processing the transposition, the theme note is transposed by s semitones. To make the music harmonious and natural, adjustments are made at set intervals, and usually when the theme note is long.

The music synthesizer 17 synthesizes digitally recorded music text 15 into actual music waves, which, together with the user's voice, are output by a mixer 18. When transposition is needed, the scale parameter in the music synthesizer 17 is adjusted. In practice, all the notes in the music text 15 are increased or decreased by several scales. The number of scales here is usually smaller than or equal to 6 semitones. But there is no limit, because 12 semitones (8 degrees tone) mean a difference of frequency by two times. In tone sense, the frequency difference by two times sounds the same. When it is higher than 6 semitones, falling tone can be used; when it is lower than 6 semitones, rising tone can be used.

Below is an example of practice:

When playing the background music, start recording, and set the sound format as monotone 16 bits, sampling frequency as 44100 Hz, and the length of each recording as 0.1 sec. In the next step, use the tone estimator 11 to calculate the fundamental frequency of the singer's voice. The method is as follows: Assume the sound recorded is:

x(n), n=0, 1, 2, . . . , N−1, N=4410, then

1. Calculate the autocorrelation function rx(k), wherein:

rₓ(k)=Σₙx(n)x(n−k), n=0, 1, 2, . . . , N−1, k=22, 23, 24, . . . , 674

The range of value k represents the frequency range to be detected:

44100/22˜44100/674=2004.54˜65.43 Hz

2. Find kₘₐₓ=arg(max(rₓ(k))|ₖ), kₘₐₓ represents the value of k when rₓ(k) has a maximum value.
3. Fundamental frequency ƒ₀=44100/kₘₐₓ. Then, convert the fundamental frequency into a scale code. Assume fundamental frequency=440 Hz, then convert it into scale A4 (tone La), scale code is 69. A difference of one semitone mean a difference of frequency by [symbol] times, and a difference of scale code by 1. The scale sequence recorder 12 will record the theme scale code in the theme scale sequence 14. In the scale matcher 13, firstly set K1=−6,K2=6, then set scale code sequence length as 4 sec (j=40). Calculate once every 0.1 seconds of recording. So there are 40 calculations in 4 seconds. Assume the theme scale sequence 14 recorded is mi, i=0, 1, 2, . . . , 39, user's voice scale sequence is ni, i=0, 1, 2, . . . , 39, transposition is s, and assume the difference of scale code mi, nk is dist (mi, nk), set dist (mi, nk)>=0, and set mi, nk different by an 8 degrees tone (12 semitones), the resulting errors of calculation will be equal, i.e.:

dist (mi, nk)=dist (mi+12*N, nk);

wherein N is an integer, and set time correction value as −1˜+0, and the scale matcher 13 will act as follow;
1. Set s=K1
2. set i=1, and set the initial value of accumulated error value sequence acu_dist[0˜39][0˜39] as a very large number 1000000
3. Calculate acu_dist [0][0]=dist (m0+s, n0)
4. Set j=i−1
5. If j>=40, skip to Step 8
6. acu_dist [i][j]=min{ acu_dist [i−1][j−1], acu_dist [i−1][j], acu_dist [i][j−1]}+dist (mi+s, nj)
7. j=j+1 If j<=i+1, back to Step 5
8. i=i+1 If i<40, back to Step 4
9. Dis(s)=dtw_dist[39][39]
10. s=s+1
11. If s<=K2, back to Step 2
12. End.

Then, In the transposition judger 16, if Dis(sₘᵢₙ)<=40 (40 is an empirical value), and the length of theme note under play>=1 sec, then transpose the theme note by sₘᵢₙ semitones, and carry out the next transposition after an interval of more than 4 sec (4 sec is an empirical value); At last, the music synthesizer 17 synthesizes digitally recorded music text into actual music waves, which are then output together with the user's voice by the mixer 18 and speaker 19.

1. An automatic tone-following method for music accompanying devices, the method comprising the steps of:
providing a tone estimator to calculate the fundamental frequency of the user's voice at set intervals;
converting fundamental frequency of the user's voice in a scale sequence recorder into user scale sequence, which is then recorded;
comparing a difference between the user scale sequence and the theme scale sequence in preset music text through a scale matcher; the scale matcher comparing the difference between the user scale sequence and theme scale sequence through a method of dynamic time warping correction;
deciding on if and when a transposition is needed for the accompanying music through a transposition judger; if a transposition is needed, the scale parameter in a music synthesizer being automatically adjusted;
synthesizing digitally recorded music text into actual music waves by a music synthesizer, the waves being outputted together with the user's voice by the mixer and the speaker.

2. The method defined in claim 1, wherein the music synthesizer adjusts the scale parameter by increase or decrease by several scales of all the note scales in the music text.

3. The method defined in claim 2, wherein the number of scales must be smaller than or equal to 6 semitones.

4. The method defined in claim 1, wherein the theme scale sequence is recorded in advance in the music text.

5. An automatic tone-following system for music accompanying devices, comprising:
a tone estimator means to calculate the fundamental frequency of the user's voice at set intervals;
a scale sequence recorder means to convert the fundamental frequency of the user's voice into user scale sequence and to record the fundamental frequency;
a scale matcher means to compare the difference between the user scale sequence and the theme scale sequence in preset music text, the scale matcher comparing the difference between the user scale sequence and theme scale sequence through a method of dynamic time warping correction;
a transposition judger means to judge if and when a transposition is needed for the accompanying music;
a music synthesizer to automatically adjust the scale parameter in the music synthesizer when the transposition judger decides a transposition is needed; the music synthesizer synthesizes digitally recorded music text into actual music waves, which are then outputted together with the user's voice by a preset mixer.
